(19) United States
(12) Patent Application Publication
(10) Pub. No.: US 2003/0190960 A1
(43) Pub. Date: Oct. 9, 2003

(54) Method and system for providing access to and administering online gaming leagues and tournaments

(76) Inventors: Eron Jokipii, Sunnyvale, CA (US); Chad Lee Walker, Mountain View, CA (US); Michael Pilip, Sunnyvale, CA (US)

Correspondence Address: James J. DeCarlo, Esq., Stroock & Stroock & Lavan LLP, 180 Maiden Lane, New York, NY, 10038, US

(21) Appl. No.: 10/406,878

(22) Filed: Apr. 4, 2003

Related U.S. Application Data
(60) Provisional application No. 60/370,928, filed on Apr. 4, 2002.

(51) Int. Cl. G06F 17/00

(52) U.S. Cl. 463/42

(57) ABSTRACT

An online gaming system operative in a client-server environment is provided in which users are provided comprehensive tools and functionalities for creating and managing online gaming leagues in which a group of member users can play the online games with and against one another in a scheduled and organized fashion. Moreover, said online gaming system enables users to create tournaments in which member users compete against one another in various tournament schemes, and records game results so as to rank and rate players relative to one another.

### CROSS-REFERENCE TO RELATED APPLICATIONS

This application claims priority to co-pending U.S. Provisional Application Serial No. 60/370,928, filed Apr. 4, 2002, the entire disclosure of which is incorporated herein by reference.

### FIELD OF THE INVENTION

The present invention is directed to networked gaming and, more particularly, to providing a method and system for administering tournament and league play as part of integral to such network gaming.

### BACKGROUND OF THE INVENTION

Present systems providing access to online gaming environments fail to provide comprehensive tools for creating and maintaining public and private leagues and creating and administering tournaments. Thus, present systems and methods do not permit users to create leagues in which the users (i.e., the members of the league) are in control over management, membership, and direction of the league. Moreover, present system and methods do not enable users to create customized tournaments or permit users to attain desirable ratings or rankings based on game play.

### SUMMARY OF THE INVENTION

The exemplary embodiments of the invention described herein are generally related to online gaming. The term “online gaming” refers to games such as chess, checkers, poker, blackjack, and the like that can be played via a communications network such as the Internet. It should be understood that while the exemplary embodiments described herein are discussed in relation generally to the Internet, computer games accessible to user via any communications network now known or heretofore developed is within the scope of the present invention.

By way of example only, the Yahoo! Games section of the Yahoo! Web site provides users with access to a multitude of gaming choices, including but not limited to card games (e.g., poker), arcade style games (e.g., electronic pool), board and tile games (e.g., chess, checkers, or backgammon), word games (e.g., crosswords), and countless others. Users can access and play the games on any computer having access to the Internet via a modem or broadband connection.

The method and system of the present invention in an exemplary embodiment permits users to create and manage leagues in which a group of member users can play the online games with and against one another in a scheduled and organized fashion. Moreover, a further feature of said exemplary embodiment enables the league administrator (e.g., the user that created the league or a user designated by league members) to create a tournament in which member users compete against one another in various tournament schemes. For instance, a single elimination checkers tournament can be created with the winner being awarded a prize. The prize may simply be an image of a trophy in the user's profile, or may be any other form of prize either in tangible or intangible form, as a matter of design choice.

In an exemplary embodiment, the method and system of the present invention operates in a server-client environment across a public communications network, such as the Internet. The server side of the server-client environment preferably comprises a web server for providing access to web pages forming the graphical user interface of the online gaming system. Through the web server, the user interacts with various components of the online gaming system, including but not limited to choosing games to play, creating and managing leagues and tournaments, and interacting with other users of the online gaming system. The server side of the server-client environment also preferably comprises a game room server for providing the graphical user interface (“GUI”) and functionality that controls the online games. Further, the server side of the server-client environment preferably comprises a league administration server for providing the functionality enabling users to create and manage leagues and tournaments, and a league database for storing user, league and tournament information, such as for example user ratings, league standings, and tournament results.

In an alternate exemplary embodiment, the server side of the client-server environment further comprises a ratings server that tracks users' usage of the online gaming system and rates users according to several categories, including but not limited to win/loss ratio, subjective ratings of fellow users, timeliness, and the like.

The client-side preferably comprises a computing device with connectivity to the Internet or other communications network. In an exemplary embodiment, the online gaming system pushes a game client to the user's computing device via the network to provide the functionality to play the selected online games. In general, the game client is an application comprising at least part of the programming, graphical images, sounds, and other components necessary for an online game to operate. In an exemplary embodiment, the game client is a relatively small file and the majority of the game processing is performed by the game server of the online gaming system to decrease the time needed to download the game client. However, persons of skill will recognize that the game client can be a file of any size comprising as little or as much of the programming, graphical images, sounds, and other components necessary to provide the user interface and functionality of the online game.

Through the game server, two or more users, depending on the particular game being played, can play the selected game against one another in “real-time”. As used herein, the term “real-time” generally refers to actions or events that occur almost instantaneously or without appreciable delay. In other words, for example, if user 1 moves a chess piece on her computing device, user 2 sees an updated chessboard almost immediately. How close the gaming environment actually comes to achieving “real-time” depends mostly on the speed of the users' respective computing devices, the speed of the network connection and modem, the amount of traffic load on the online gaming system and other variables known to cause delay in the transmission of data via the Internet or other networks.

Other objects and features of the present invention will become apparent from the following detailed description, considered in conjunction with the accompanying system schematics and flow diagrams. It is understood, however, that the drawings, which are not to scale, are designed solely for the purpose of illustration and not as a definition of the limits of the invention, for which reference should be made to the attended claims.

### BRIEF DESCRIPTION OF THE DRAWINGS

In the drawing figures, which are merely illustrative, and wherein like reference numerals depict like elements throughout the several views:

FIG. 1 is a schematic diagram of an overview of an exemplary embodiment of the system architecture of an online gaming system in accordance with the present invention;

FIG. 2 is an exemplary interface for permitting user to create an online gaming league;

FIG. 3 is a further exemplary interface for permitting user to create an online gaming league;

FIG. 4 is an exemplary interface for managing an online gaining league;

FIG. 5 is an exemplary interface for creating online gaming tournament;

FIG. 6 is an exemplary gaming interface; and

FIG. 7 is an exemplary interface of a game room in which users can join or watch online games.

### DETAILED DESCRIPTION OF THE EXEMPLARY EMBODIMENTS

There will now be shown and described in connection with the attached drawing figures several exemplary embodiments of a system and method of providing access to and administering online gaming leagues and tournaments.

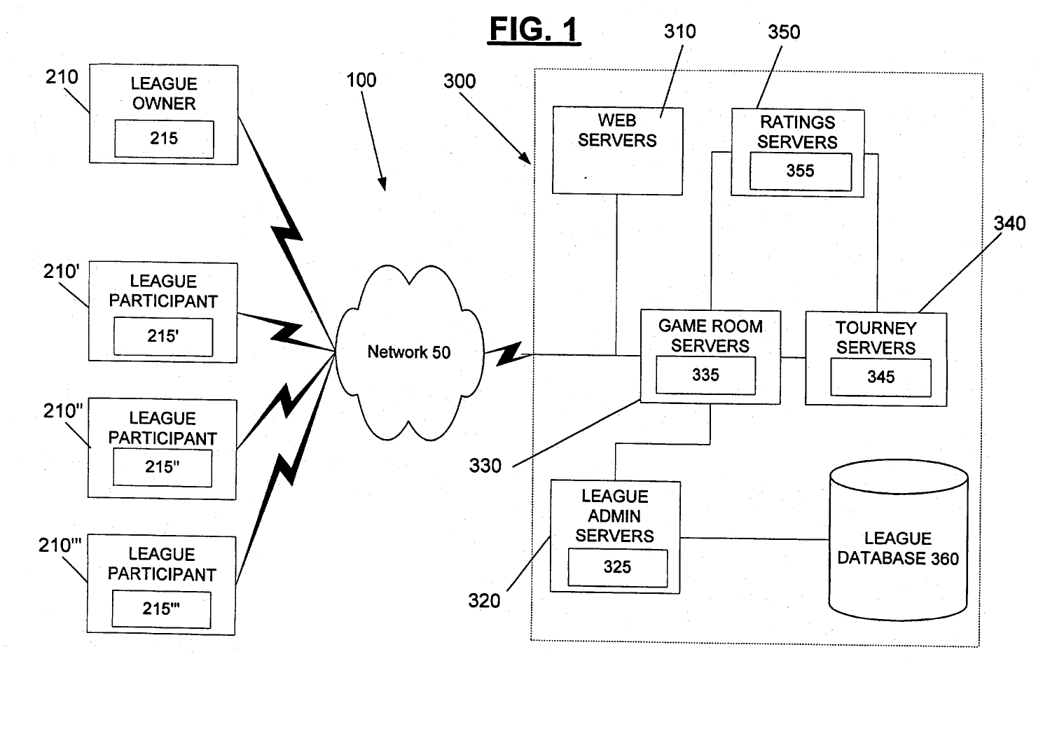

In an exemplary embodiment, as shown in FIGS. 1 through 7, an online gaming system 100 for playing online computer games generally comprises a league engine 325 operative on a league administration server 320 for permitting users of the online gaming system 100 to create and manage an online gaming league, the league engine 325 providing access to league information to members of the league; a game engine 335 operative on a game room server 330 for controlling play of the online games; and a tournament engine 345 operative on a tournament server 340 enabling league members to create and participate in online gaming tournaments, the tournament engine 345 recording results of online games played by members and managing progress of the online gaming tournament. The tournament system preferably further comprises a ratings engine 355 for ranking the skill level of league members by calculating a rating for each league member.

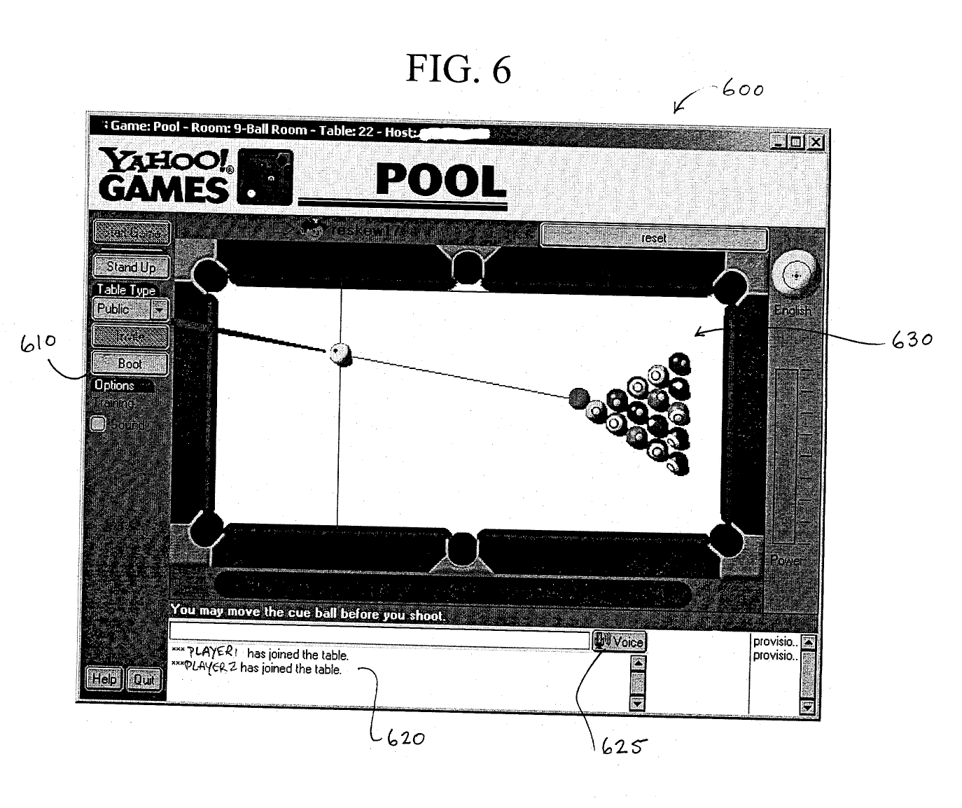

According to an exemplary embodiment, a game room generally refers to the game application triggered when a user of the online gaming system desires to play a particular online game. The game room preferably features a graphical interface, as shown and described below in connection with FIG. 6, in order to facilitate game play. A user can create a game room by selecting an online game type and entering certain customized information about the game room, such as by way of example a game room name, game room description, and whether the game room will host ladder ranking games. The user may also set whether the room will be a private room available to only league members or a public room open to all members of the online gaming system. The game room or table type determines how easy it is for other players to get to your table. There are preferably at least three table types: public, private, and protected. The host of the table chooses the table type. Public tables or game rooms are available to all members of the online gaming system to join or watch. Protected tables or game rooms are only available to invited players, but any member of the online gaming system can watch. Private tables or game rooms are only available to invited players.

In an exemplary embodiment, game rooms permit users to engage in voice chat or traditional messaging. Players can either chat in a public chat area in which the chat may be seen by all users or players can send a private message to a fellow player. To chat publicly, a user may utilize a chat area, as discussed below, in the game room to send the message.

Game rooms are preferably loosely organized by skill level. Exemplary skill levels range from beginner, intermediate, and advanced. Social rooms are for players who prefer a more casual experience. Ladder rooms are for people who want to play on our ladder system. Users may choose to watch or play games in any level.

System Architecture

With reference to FIG. 1, there is shown an exemplary embodiment of a online gaming system 100 operating in a client-server environment in accordance with the present invention. The client-server environment comprises a client-side 200 and a server-side 300.

The online gaming system 100 generally comprises one or more servers programmed and equipped to process data received from a plurality of user computing devices 210. In the exemplary embodiment shown in FIG. 1, the online gaming system 100 comprises a web server 310 for providing web pages to the viewers and players, a league administration server 320 for enabling the creation and management of leagues (both private and public) for playing online games, a game room server 330 for creating and monitoring/tracking game rooms and maintaining the game state, including tracking players in the room, what tables are open/closed and making the progress and results available to the systems and players/viewers, and a tournament server 340 for providing tournament functionality. The online gaming system 100 may further comprise a ratings server 350 for tracking the results of online games played by or between users and assigning ratings or rankings to the players.

It will be understood that each of the servers 310, 320, 330, 340, and 350 of the server-side 300 of the online gaming system 100 are each communicatively connected via a local or wide area network 305 (“LAN” or “WAN”). In turn, server-side 300 of the online gaming system 100 is in communicative connection with the client-side 200 via network 50.

Each server is preferably coupled (e.g., via a TCP/IP socket) to an electronic storage device, such as league database 360, containing a database of relevant information. Such information may include player information (for each player (as identified by player ID): username, password, player ID, contact information, league(s) Ids, tournament Ids, play history, and other player specific information used in allowing and tracking user play), game information (for each game (as identified by game ID): type of game, players in game, progress of game, results and the like), tournament information (for each tournament (as identified by tournament ID): player creating the tournament, indication (e.g., flag) of whether the tournament is open to only members of the creating player's league(s), number of players, tournament schedule, games associated with the tournament (as identified by game ID), type of game/tournament, players, results of games, results of tournament, and the like), league information (for each league (as identified by league ID): the players (as identified by ID) in the league, standings or ratings of the players, games/tournaments history and/or schedule and the like) and various other information apparent from the following description. For example, the online gaming system 100 may further comprise league database 360, as shown in FIG. 1, to store and manage the above-referenced information. As will be appreciated by those skilled in the art, such information may be stored in any number of related databases and/or tables.

One skilled in the art will recognize that the user computing devices may be any type of computer capable of transmitting and receiving data via network 50 to the server-side 300 of the online gaming system 100. By way of example, computing devices 210 may be a personal desktop, laptop, or tablet computer, a handheld computing device (e.g., a PDA or pocket pc), a mobile telephone, or blackberry to name a few.

Operation of the Online Gaming System

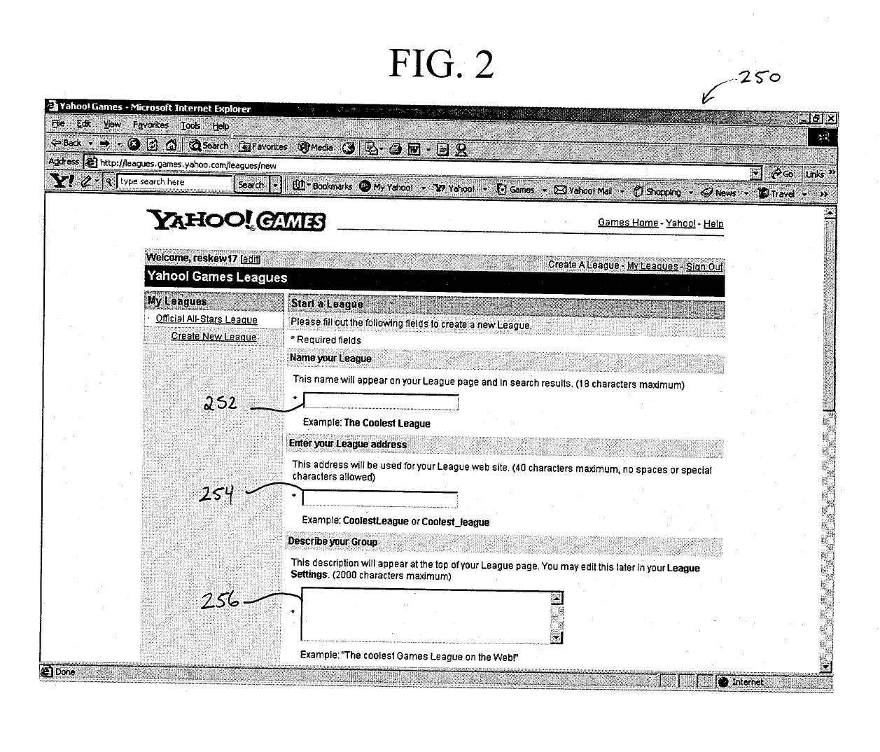

In connection with FIGS. 2-10, they will shown and described an exemplary embodiment of use interfaces through which one or more users may interact with the online gaming system 100 described herein. For illustrative purposes only, users of the online gaming system 100 will be referred to herein in two general categories: league administrators who are users desiring to create and administer a league for playing online games, and league participants or league members who are users who are members of one or more leagues created with the online gaming system 100.

The online gaming system 100 enables league administrators to create leagues using available league management tools made available to users via the league engine 325 operative on the league administration servers 320 of the online gaming system 100 in combination with the web servers 310, which serve graphical interfaces via network 50 to users. The league engine 325 is preferably programming coded in any available programming language, such as Java, C++, Visual Basic, or the like, to provide the functionality describe herein. In general, the league engine 325 preferably enables league administrators to create and manage private or public games rooms, create and manage ladders and ratings of league members, create and manage tournaments, and control player access. Persons of skill will recognize that additional features can be programmed into the league engine 325 to enhance league creation and management.

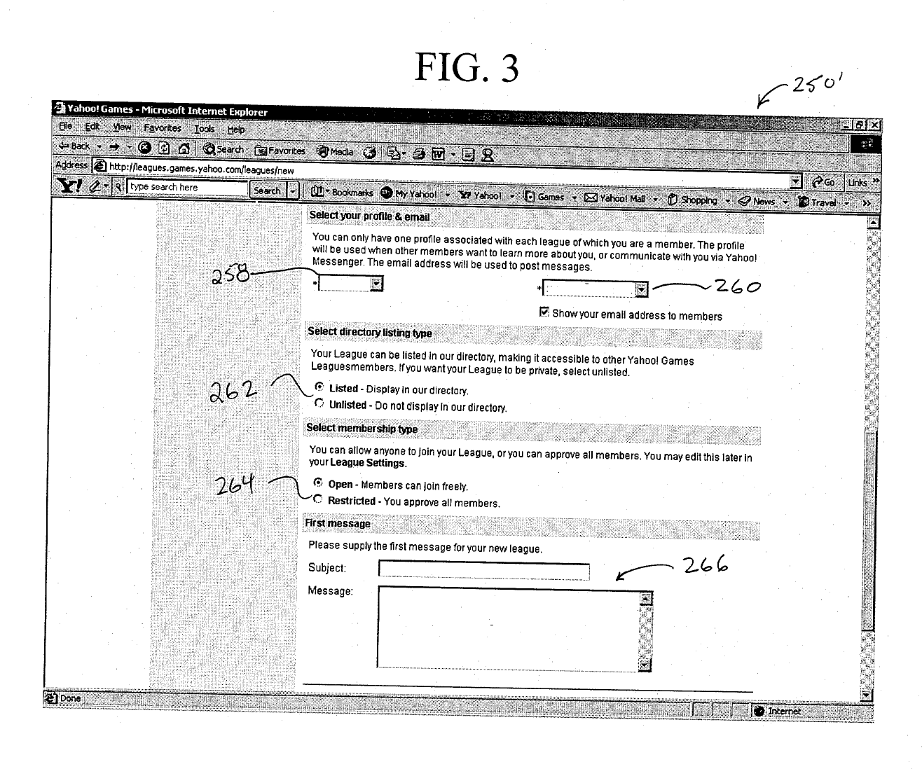

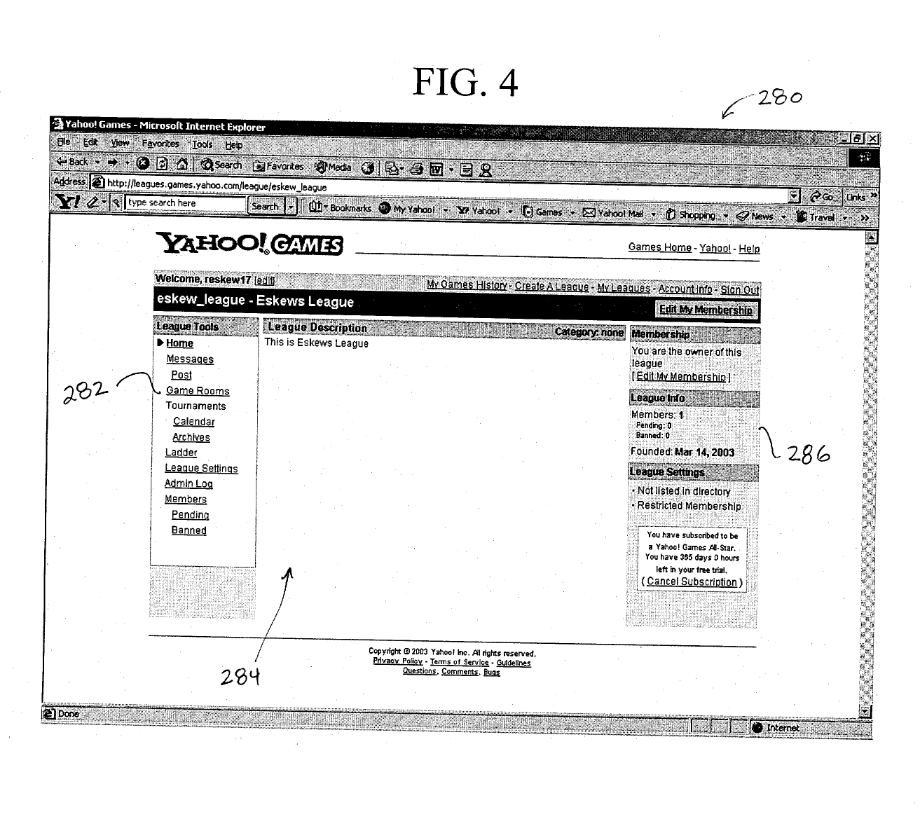

As shown in FIG. 2, a league administrator can start a league by accessing a new league user interface 250 on the online gaming system 100 website via the user's computer device 210. According to an exemplary embodiment, the user can enter a league name and a league url address through which users of the league can communicate, and a description of the league in input boxes 252, 254, 256. Further, as shown in FIG. 3, the league administrator creates a profile using interface 250′ including a profile name 258, an e-mail address 260 and decides whether or not the league will be listed in a league directory using radio buttons 262, whether the league will be open or restricted using radio buttons 264, and may place a message to league members using input box 266. As shown in FIG. 4, the online gaming system 100 provides after set-up of a league, a league homepage in which various settings applicable to the league may be set. As further shown in the user interface 280 of FIG. 4, a number of options may be linked to via the league homepage using toolbar interface 282. An exemplary listing to the tools available to a league administrator is also shown in FIG. 4. For example, messages may be transmitted to other league members, various game rooms can be accessed via the league homepage, tournaments can be created and accessed, a tournament ladder may be viewed, league setting may be modified, a log of administrative actions may be viewed and information pertaining to the various members of the league may be accessed. The exemplary interface 280 of FIG. 4 also preferably includes an information window 284 in which league information, such as the league description, upcoming tournaments, or game room information, may be shown. The exemplary interface 280 of FIG. 4 also preferably includes a membership information toolbar in which members can edit or view their membership information, view general information regarding league membership or change their subscription status.

The online gaming system 100 also preferably enables league administrators to create tournaments in which several members of the league can participate in a selected game. A tournament engine 345 operative on the tournament servers 340 of the online gaming system 100 provides the functionality to create and manage tournaments. According to an exemplary embodiment, the tournament engine 345 enables users to set tournament names, select a particular game room at which the tournament will be played, describe the tournament, establish game settings, such as the allotted time per move, set the pairing system (described further below), set signup date and times, set the number of participants, set the date and time that the tournament starts, set the time per round, and select whether the tournament will be private or open to public users. Persons of skill will recognize that additional features can be programmed into the tournament engine 345 to enhance tournament creation and operation.

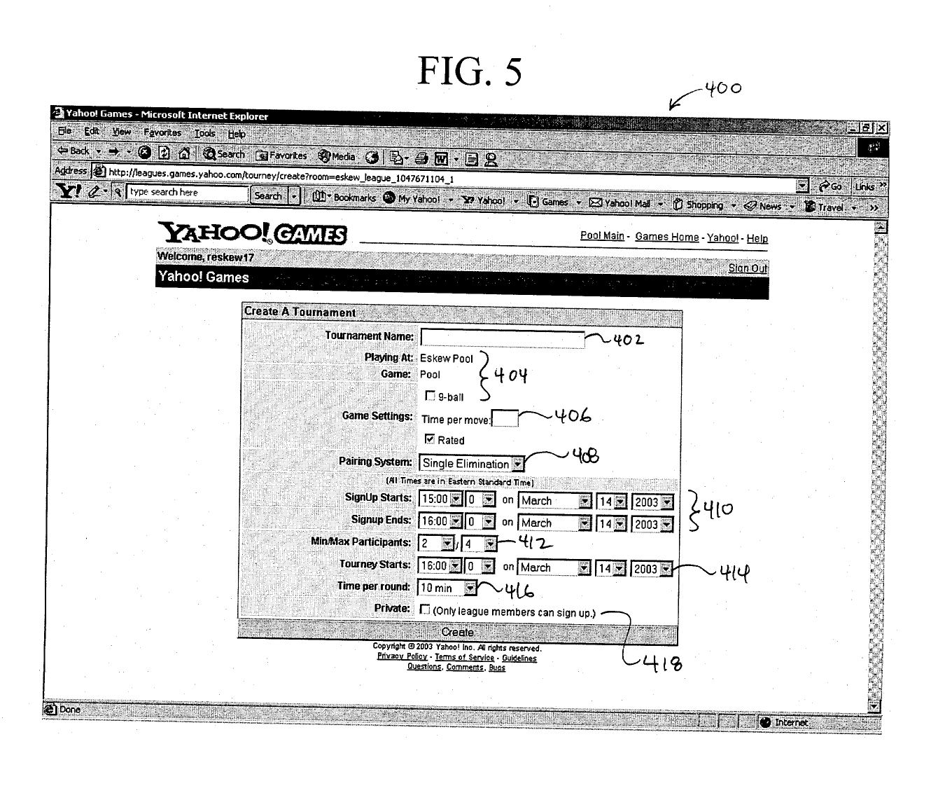

By way of example, FIG. 5 depicts an exemplary embodiment of an interface 400, permitting a user to create a tournament. As shown in the user interface 400 of FIG. 5, the league administrator can name the tournament using input box 402 the particular game room where the tournament is going to be played is selected beforehand as shown by reference numeral 404 using the league information window 284. The league administrator may also customize settings for the tournament games such as the time allowed to move using input box 406, the nature of the tournament (e.g., whether the tournament is single elimination, double elimination or some other form of tournament structure) using drop down menu 408, the date and time of the sign-up using selection boxes 410, the number of participants using selection boxes 412, the date and time of the start of the tournament using selection boxes 414, and the allotted time for each round using selection boxes 416, as shown in FIG. 5. Check box 418 permits the user to specify whether the tournament will be private or public (i.e., open to non-league members).

The tournament engine 345 preferably enables at least two types of tournament pairing systems. In one exemplary embodiment, the tournament engine 345 enables manual pairings in which the league administrator manually assigns game pairings using a tournament structure interface. In another exemplary embodiment, the tournament engine 345 automatically assigns pairings. The automatic pairing may be accomplished using a randomizer in which league participants are randomly paired, or pairing may be accomplished using the relative rankings or ratings of the league participants, or a combination of the two.

As described above, the tournament engine 345 permits the league administrator to customize the length of each round of a tournament. Round intervals are preferably considered complete when all of the scheduled games within a round are completed or a preset tie for each round has expired. In instances where games are unfinished by the allotted round interval time, winners may be chosen by selecting the user that used the least amount of time or by determining who was leading the game at the point time expired, as a matter of design choice.

As discussed in general above, the tournament engine 345 monitors online games being played on the online gaming system 100 to record results and manage the tournament structure. The tournament engine 345 preferably provides multiple types of tournament structures.

In one exemplary tournament structure, the tournament engine 345 provides automatic pairing and reporting of gaming results, as describe above. For instance, in a single elimination tournament, all of the pairing and the wins/losses are automatically reported. If a user wins a game, the winner is automatically seeded to the next round to play the next opponent. If there are openings in the tournament brackets, certain players receive a “bye,” meaning they have no game in that round.

In another exemplary embodiment, a tournament may be created wherein players are invited to participate in each round. According to this exemplary embodiment, at the start of a new round, players are automatically invited to the proper game table with a message indicated the invite to the game table. By responding to the message, players will automatically be seated at the table with the scheduled opponent. Games played at the invited tables are preferably reported to the standings system to enable the tournament engine 345 to monitor progress of the tournament. Once a game is over, players may exit that game table and wait for a new table invite in the next round.

Preferably, the tournament engine 345 also tracks forfeits. Thus, if an opponent is a no-show or if the opponent fails to respond after a certain time, the tournament engine 345 will record a victory for the player present at the game table.

Based on the results of a tournament, the tournament engine 345 can award trophies that can be seen in the player's profile page.

Online Game Generation and Play

According to an exemplary embodiment, a game client 215 is downloaded to the computing devices 210 of the users during registration of the user with the online gaming system 100. The game client 215, which as described above is preferably a relatively small software application such as an applet, enables the user's computing device 210 to communicate with the game engine 335 operative on the server-side 300 to enable play of selected online games. FIG. 6 depicts and exemplary online game interface 600 generated by the game engine 335 and displayed on a display of the user's computing device 210. In the exemplary embodiment shown in FIG. 6, the game interface 600 preferably comprises a toolbar 610 for navigating game functions. For example, buttons may be provided to start and end games and to set certain game parameters. The game interface 600 may also comprise a chat interface 620 or an interface for voice messaging 625. Further, the game interface 600 comprises a graphical display 630 of the game table in the example shown in FIG. 6 a pool table.

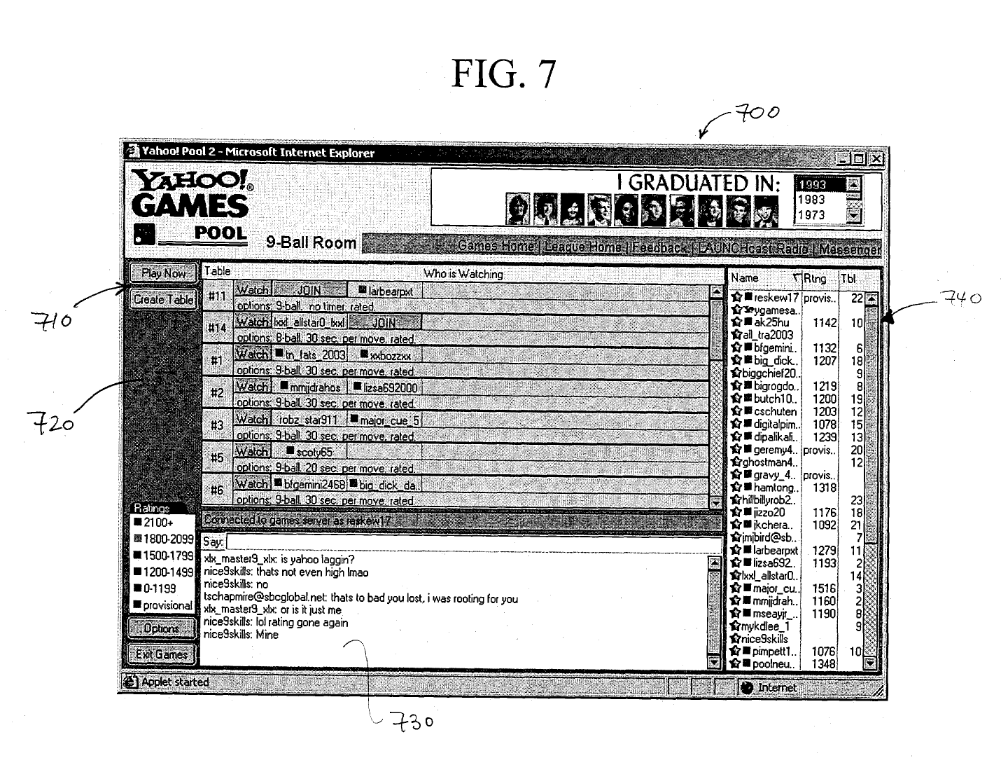

As further shown in FIG. 7, a game room interface 700 is provided wherein users can view ongoing or open inline games. A game table information window 720 lists current game tables so that users can determine whether there are any game tables that they can join or whether any games that might be interesting to view are being played. The game table information window also preferably depicts each players rating using a color code. By way of example, this permits users to find evenly matched players to engage in a game or enables user to locate games against highly rated players that may be of interest. The game room interface also preferably includes a toolbar 710 to enable a user to create his/her own table or to initiate play. A chat interface 730 is also preferably included. Further, a player-listing window 740 lists all players in the game room, along with their respective ratings and game table location.

In operation, once a league and tournament are created, the system 100 preferably marshals players within the league to the proper game room where selected online games may be played. The system 100 also preferably monitors the progress of all of the online games within each tournament, tallies the results and determines the winner(s). The tournament server 340 and game room server 330 communicate during the process via a TCP/IP connection, for example. In general, the tournament server 340 determines that a game is to take place between certain players as part of the tournament and communicates the need to create the game to the game room server 330; the game room server 330 creates a game room, such as game interface 600, for the particular players. In certain embodiments, the game room (or other) server generates a message and sends it to the appropriate users' computers 210 on which game client 215 software resides. In other embodiments, the game room server 330 creates game rooms dynamically, in response to a player request (e.g., clicking a link or button). In such embodiments, the system 100 first determines whether or not the request room is valid (e.g., by comparing player, level of service, type of game, tournament, league etc.). In the event the game room is valid, the game server 330 creates the game, storing the parameters in the database and generates the graphical display for the player(s), and the players are permitted to connect to the game room.

The game engine 335, and in an exemplary embodiment the game client 215, provides the programming to drive game play. For example, with reference to FIG. 6, the game engine 335 and game client 215 receive user inputs from the user's computer 210 indicating that the cue stick 650 is moved to a certain location relative to the cue ball 655 to aim the cue ball in a desired direction. The game engine 335 upon receipt of such input data generates a graphical representation of the user input. The game engine 335 also tracks other attributes of the gaming environment such as, in the example of FIG. 6, which pool balls have been pocketed and by which player.

As discussed above, the online gaming system 100 may also comprise a ratings server 350 operable with a ratings engine 355 to rate and rank users according to certain criteria.

In one exemplary embodiment, the ratings engine 355 ranks league members at least based in part on the result of the online game and the difference between the rating for each league member participating in the online game. In another exemplary embodiment, the ratings engine 355 rates players according to known and published game ratings standards, such as the ratings systems of the U.S. Chess Federation (USCF) or the First Internet Backgammon Server (FIBS) to name a few.

In yet another alternate embodiment, the ratings engine 355 ranks league members according to a ladder system. In such embodiments, the ratings engine 355 ranks players according to rungs on a ladder. In other words, if there are ten ladder rungs, the higher the rung the more wins a player has against competition. Thus, winning an online game against a higher ranked league member causes the player to move up a rung, and losing an online game against a lower league member causes the player to move down a rung in one form of the ladder ratings system, members must defend their rung by playing lower ranked league members at least a preset number of times in a given time period. Further, in another form of the ladder ratings system, if a lower ranked player wins an online game against a higher ranked player, the lower ranked player moves up half the number of rungs between the rung of the lower ranked player and the rung of the higher ranked player, and the higher ranked player moves down at least one rung. Thus, if the lower player is ranked 30 of 100 and the higher player is ranked 10 of 100, the lower player will be moved up 10 rungs (½ of 30 minus 10) to rung 20 and the higher ranked player will be moved down to rung 11. The player formally at rung 11 is automatically moved up to rung 10 to take the other player's place.

While the invention has been described in connection with exemplary embodiments, it will be understood that modifications thereof within the principles outlined above will be evident to those skilled in the art and thus, the invention is not limited to the exemplary embodiments but is intended to encompass such modifications.

What is claimed is:

1. An tournament system for playing online computer games, the tournament system comprising:
a league engine for permitting users of an online gaming system to create and manage an online gaming league, the league engine providing access to league information to members of the league;
a game engine for controlling play of the online games; and
a tournament engine enabling league members to create and participate in online gaming tournaments, the tournament engine recording results of online games played by members and managing progress of the online gaming tournament.

2. The tournament system of claim 1, further comprising a ratings engine for ranking the skill level of league members by calculating a rating for each league member.

3. The tournament system of claim 2, wherein the ratings engine ranks league members at least based in part on the result of the online game and the difference between the rating for each league member participating in the online game.

4. The tournament system of claim 2, wherein the ratings engine ranks league members according to a ladder system in which league members are ranked according to rungs on a ladder and wherein winning an online game against a higher ranked league member move up a rung, and league members losing an online game against a lower league member move down a rung.

5. The tournament system of claim 4 wherein league members must defend their rung by playing lower ranked league members at least a preset number of times in a given time period.

6. The tournament system of claim 4, wherein if a lower ranked player wins an online game against a higher ranked player, the lower ranked player moves up half the number of rungs between the rung of the lower ranked player and the rung of the higher ranked player, and the higher ranked player moves down at least one rung.

7. The tournament server of claim 1, wherein the league engine provides a plurality of league management tools.

8. The tournament server of claim 7, wherein the league management tools include a private game room creation tool.

9. The tournament server of claim 7, wherein the league management tools include a ratings management tool.

10. The tournament server of claim 1, wherein the tournament engine enables creation of a tournament having a single elimination format.

11. The tournament server of claim 1, wherein the tournament engine enables creating of a tournament having a double elimination format.

12. The tournament server of claim 1, wherein tournament pairings are automatically assigned by the tournament engine.

13. The tournament server of claim 1, wherein tournament pairings are automatically assigned by the league member designated as a league administrator.

14. A method of administering an online gaming tournament in which a plurality of users access an online gaming system via a network; the method comprising:
providing access to a gaming environment via a communications network, wherein the gaming environment comprises a plurality of user created game rooms for playing selected online games, the online gaming system providing the functionality and user interface to enable game play;
enabling a user of the online gaming system to create a league in which at least a portion of said plurality of users are members of the league; and
enabling members of the league to create an online gaming tournament in which members play a selected online game against one another in a tournament format, the members of the league customizing the tournament format as desired.

15. The method of claim 14 further comprising recording results of the online games played during the online gaming tournament so as to manage the advance of winning players through the tournament format.

16. The method of claim 14 further comprising rating players based on the result of games played during the online gaming tournament.

17. The method of claim 16 wherein players are rated at least based in part on a difference in a rating for each respective player participating in the online game.

18. The method of claim 14 wherein players are ranked according to a ladder system in which players are ranked according to rungs on a ladder and wherein winning an online game against a higher ranked player causes the player to move up a rung, and players losing an online game against a lower ranked player causes the losing player to move down a rung.

19. The method of claim 18 wherein players must defend their rung by playing lower ranked players at least a preset number of times in a given time period.

20. The method of claim 18 wherein if a lower ranked player wins an online game against a higher ranked player, the lower ranked player moves up half the number of rungs between the rung of the lower ranked player and the rung of the higher ranked player, and the higher ranked player moves down at least one rung.
